(19) United States
(12) Patent Application Publication
(10) Pub. No.: US 2024/0153028 A1
(43) Pub. Date: May 9, 2024

(54) SMART-VENUE WAGERING SYSTEM AND METHOD FOR LIVE EVENTS

(71) Applicant: BETS FLOW LTD., Tel Aviv (IL)

(72) Inventor: Tal Arieh HAYON, Omer (IL)

(73) Assignee: BETS FLOW LTD., Tel Aviv (IL)

(21) Appl. No.: 18/414,950

(22) Filed: Jan. 17, 2024

Related U.S. Application Data
(63) Continuation of application No. 17/252,735, filed on Dec. 16, 2020, now abandoned.
(60) Provisional application No. 62/686,153, filed on Jun. 18, 2018.

(51) Int. Cl. G06Q 50/34; G07F 17/32

(52) U.S. Cl. CPC G06Q 50/34; G07F 17/3206; G07F 17/323; G07F 17/3239; G07F 17/3269; G07F 17/3288

(57) ABSTRACT

A system for providing a computer based wagering game during a live event, comprising: one or more sensors for obtaining in-venue data, at least one source for providing statistical information relative to the live event, and a processing unit, configured to receive data from the at least one source and in-venue data from the one or more sensors, to calculate, in accordance with the real-time situation/development of the live event, the occurrence probability of one or more outcomes of evolving situations and their corresponding odds in a specific period of time during the progress of the live event, and to generate one or more betting events, wherein each of the betting events is based on the probability calculation and corresponding odds.

### FIELD OF THE INVENTION

The present invention relates to the field of gaming network platform. More particularly, the invention relates to a method and system for providing a smart-venue based wagering game during a live event, in particular by using a plurality of Internet of things (IoT) sensors to collect and analyze in-venue data in combination with statistical information to generate dynamic betting events.

### BACKGROUND OF THE INVENTION

Sports contests are typically based on real-life team athletic competitions (e.g., football, baseball, basketball, hockey, soccer, rugby, etc.), real-life athletic competitions in which individuals compete (e.g., golf, tennis, automotive racing, etc.), real-life sporting events involving animals (e.g., horse and dog racing) and virtual sports such as fantasy sports (e.g., virtual football).

Users may find it desirable to wager on real-life events, such as live sporting events (e.g., soccer, football, baseball, basketball, etc.). For example, in addition to trivial wagering outcomes, such as which one of the sports contestants will win, under/over 1.5 goals, etc., users may find it desirable to wager on variety of possible situations that may occur during these real-life events and which may derived from statistics (e.g., team/individual performance in past games, league table) and real-time data that may involve in-venue data (e.g., weather, pitch conditions, crowd, etc.), team or individuals performance (e.g., in terms of mental and physical aspects) during the live event.

Therefore, a need remains for systems and methods that may efficiently generate substantially real-time wagering game based on events that may occur during real-life events, such as live sporting event.

It is an object of the present invention to provide a system which is capable of efficiently generating substantially real-time wagering game based on team or individuals performance during the live event.

Other objects and advantages of the invention will become apparent as the description proceeds.

### SUMMARY OF THE INVENTION

A method for providing a smart-venue based wagering game during a live event, comprising:
receiving, in real-time from one or more sensors, in-venue data;
receiving data relative to statistical information relative to said live event;
utilizing said received data and in-venue data for calculating in accordance with the real-time situation/development of the live event the occurrence probability of one or more outcomes of evolving situations and their corresponding odds in a specific period of time during the progress of said live event; and
generating one or more betting events, by a processing unit (e.g., that can be implemented in a game server), wherein each of said betting event is based on said probability calculation and corresponding odds.

According to an embodiment of the invention, the one or more sensors are selected from the group consisting of: wearable sensors that are configured to provide real-time data relative to physical performance of the wearer, motion tracking sensors, “in-field” sensors, cameras or any combination thereof.

According to an embodiment of the invention, the wearable sensors are miniature magneto-inertial sensors or other types of sensors suitable to provide data relative to activities that occur in real-time during live sporting events.

According to an embodiment of the invention, the “in-field” sensors configured to provide data relative to the weather, pitch condition, crowd or any other form of in-venue data.

According to an embodiment of the invention, the in-venue data is relative to performance of a team and/or one or more individual players.

In another aspect, the present invention relates to a system for providing a computer based wagering game during a live event, comprising: one or more sensors for obtaining in-venue data, at least one source for providing statistical information relative to said live event, and a processing unit, configured to receive data from the at least one source and in-venue data from the one or more sensors, to calculate, in accordance with the real-time situation/development of the live event, the occurrence probability of one or more outcomes of evolving situations and their corresponding odds in a specific period of time during the progress of said live event, and to generate one or more betting events, wherein each of said betting events is based on said probability calculation and corresponding odds.

According to an embodiment of the invention, the system further comprises a betting widget for interfacing with the wagering game through external computing environments (e.g., third-party wagering systems).

### BRIEF DESCRIPTION OF THE DRAWINGS

In the drawings:

FIG. 1A is a flow chart generally illustrating an embodiment of the invention;

FIG. 1B is a block diagram representing a possible configuration of the computing elements of the proposed wagering system, according to an embodiment of the invention;

FIG. 2 schematically illustrates an exemplary user interface that can be implemented at set-top boxes, according to one embodiment of the present invention;

FIG. 3 schematically illustrates an implementation of the system in a casino oriented environment, according to an embodiment of the present invention;

FIGS. 4A and 4B schematically illustrates possible implementation of the proposed wagering game during a live tennis match between two players, according to an embodiment of the invention;

FIGS. 5A and 5B schematically illustrates possible implementation of the proposed wagering game during a live soccer match between two teams, according to an embodiment of the invention;

FIGS. 6A and 6B schematically illustrates possible implementation of the proposed wagering game during a live basketball match between two teams, according to an embodiment of the invention;

FIGS. 7A and 7B illustrate further possible implementations of the proposed wagering game, according to an embodiment of the invention; and

FIG. 8 illustrates examples of possible implementations of the proposed wagering game, according to an embodiment of the invention.

### DETAILED DESCRIPTION OF THE INVENTION

Throughout this description the term “sporting event” is used to indicate a single game or match. However, it will be appreciated that virtually any real-time event that has a series of repeating events with random outcomes can be considered a “sporting event”.

In the following detailed description, references are made to the accompanying drawings that form a part hereof, and in which are shown by way of illustrations specific embodiments or examples. Wherever practicable similar or like reference numbers may be used in the figures and may indicate similar or like functionality. These embodiments may be combined, other embodiments may be utilized, and structural changes may be made without departing from the spirit or scope of the present invention. The following detailed description is therefore not to be taken in a limiting sense and the scope of the present invention is defined by the appended claims and their equivalents. One skilled in the art will readily recognize from the following description that alternative embodiments of the systems and methods illustrated herein may be employed without departing from the principles of the invention described herein.

Although certain examples in this disclosure are illustrated in the context of a user wagering on a live sporting event (e.g., an athletic competition) that is currently being broadcast, it will be appreciated that many concepts of the invention may be applied to wagers on live events that are not necessarily being broadcast or that are at least partially being broadcast.

The amount of media (e.g., broadcasts of live sporting events) available to users in any given media delivery system can be substantial. Consequently, many users desire a form of media guidance through an interface that allows users to efficiently navigate media selections and easily identify media that they may desire. An application which provides such guidance is referred to herein as an interactive media guidance application or, sometimes, a media guidance application or a guidance application. Generally, the guidance application is a type of a program module that includes routines, programs, components, data structures, and other types of structures that perform particular tasks or implement particular data types. For example, the guidance application may include the broadcasting of a live sporting event, or it can be provided as an add-on layer on top of a broadcast of the live sporting event.

The wagering game suggested by the present invention can be played by a plurality of users over wide area network (e.g., the Internet) via any applicable platforms such as set-top boxes, smart-phones, personal computers, tablets, and the like. The wagering game involves a series of opportunities to wager on events associated with a live sporting event, such as a soccer, basketball or football game. The users will typically watch, listen or follow a virtual match tracker of the sporting event to a live broadcast of the sporting event, but the sporting event may also be played in an arena where the sporting event is taking place. Additionally, there are numerous situations in which the wagering game could be applied to other events that would not typically be considered “sporting events” such as the returns from an election, the outcome of a court proceeding, or the gains and losses on a stock market.

Thus, although the present invention will generally be described and claimed in the context of live sporting events, the term “sporting event” should be given the broadest possible interpretation consistent with the present disclosure and the prior art. In the foregoing examples, the outcomes of each wagering event within the sporting event are unknown. Because the outcomes are unknown, these types of wagering events can be referred to more specifically as “dynamic sporting bets”.

The following discussion is intended to provide a brief, general description of a suitable computing environment in which the invention may be implemented. While the invention will be described in the general context of program modules that execute in conjunction with an interactive media guidance application that runs on an operating system on a set-top box (STB) or computer based mobile device (e.g., a smartphone), those skilled in the art will recognize that the invention may also be implemented in combination with other program modules and computer based devices.

Moreover, those skilled in the art will appreciate that the invention may be practiced with other computer system configurations, including hand-held devices, multiprocessor systems, microprocessor-based or programmable consumer electronics, minicomputers, mainframe computers, and the like. According to an embodiment of the invention, the invention is practiced in distributed computing environments where tasks are performed by remote processing devices that are linked through a communications network. In such distributed computing environment, program modules may be located in both local and remote memory storage devices. While certain examples refer to a Set-Top Box (STB) equipment, other computer or electronic systems can be used as well, such as, without limitation, a smart TV, a Personal Computer (PC), tablet, an interactive television, a network-enabled personal digital assistant (PDA), a network game console, a networked entertainment device, a smartphone (e.g., with an operating system and on which a user can install applications), Virtual Reality (VR) devices (i.e., devices which allow remote users, outside the the venue, to virtually experience the event) or other wearable computer based devices, and so on.

Embodiments of the invention may be implemented as a computer process, a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

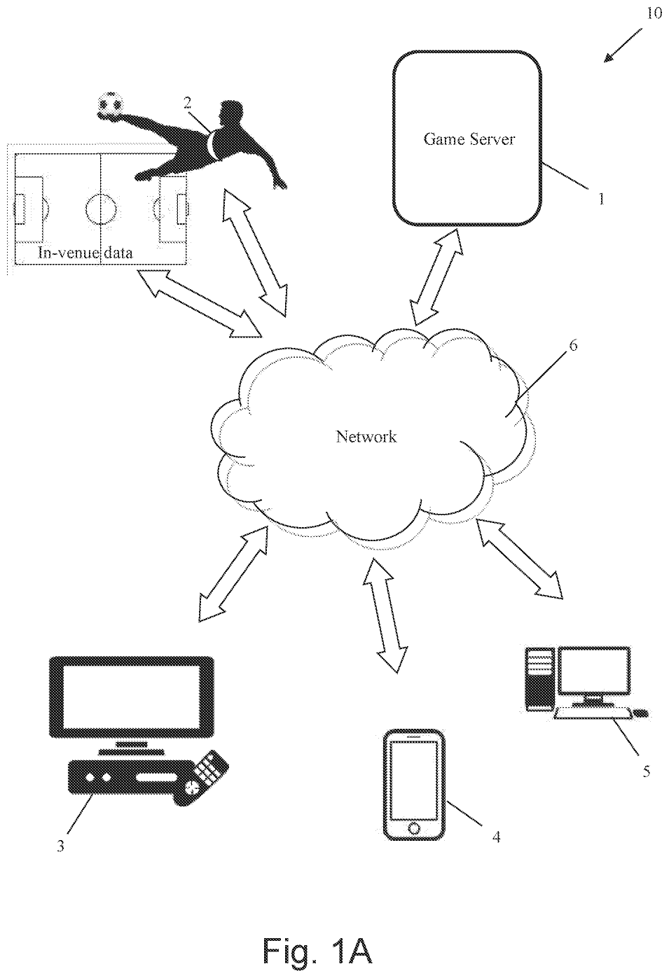

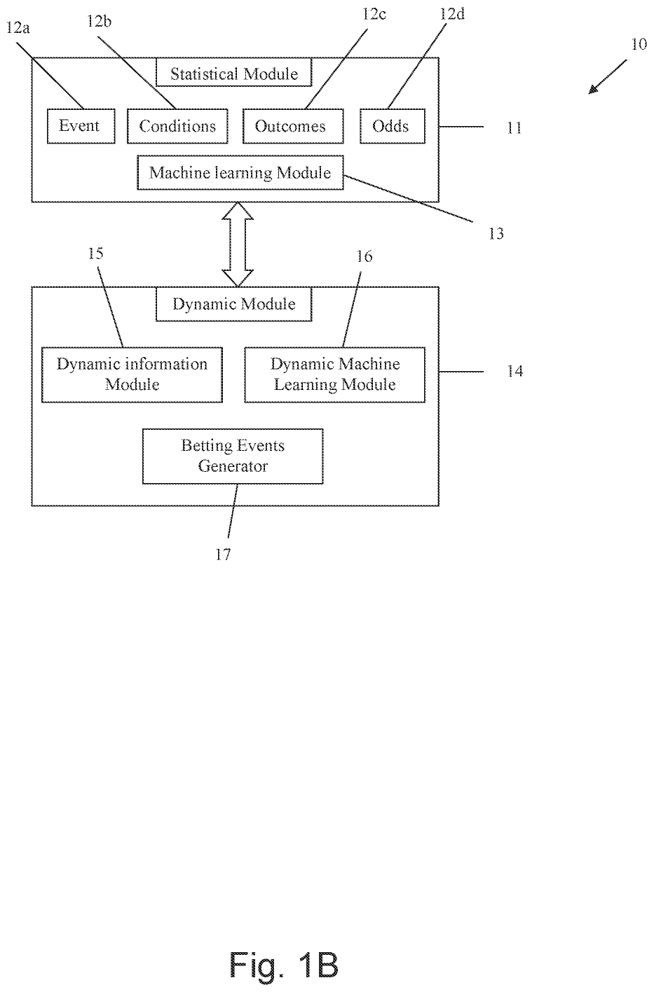

FIG. 1A schematically illustrates a system for providing a wagering game during a live sporting event, according to an embodiment of the present invention. The system generally indicated by numeral 10 in the figure comprises a game server 1, one or more sensors 2 and a plurality of users' terminal devices, such as a STB 3, a smartphone 4 and a PC 5. Sensors 2 and the terminal devices may communicate with game server 1 via a data network 6 (e.g., the Internet).

According to one aspect, the present invention relates to an online gaming platform in which users may participate in one or more betting events in order to predict outcomes of specific conditions relating to activities that may occur during one or more live sporting events. The betting events are provided by online game server 1 to an individual user, a group of users or to all users, wherein the generation of one or more betting events may involve data received from the one or more Internet of things (IoT) sensors 2 which may communicate with each other and with server 1 during the live event. For example, system 10 may operate in combination with traditional betting systems, betting exchange, pool betting and the like.

According to an embodiment of the present invention, each betting event which is generated during the live sporting event refers to a specific real-time condition (e.g., a foul shot in basketball, corner kick in soccer, field goal kick in football, etc.), where each betting event can have one or more possible outcomes (e.g., scoring 1 of 2 basketball foul shots, scoring both shots, missing both shots or scoring the first shot and catching the rebound ball of the missed second shot) and each outcome is designated with a generated odd. Following the generation of a betting event, each participating user can choose one or more desirable outcomes and enter related stakes.

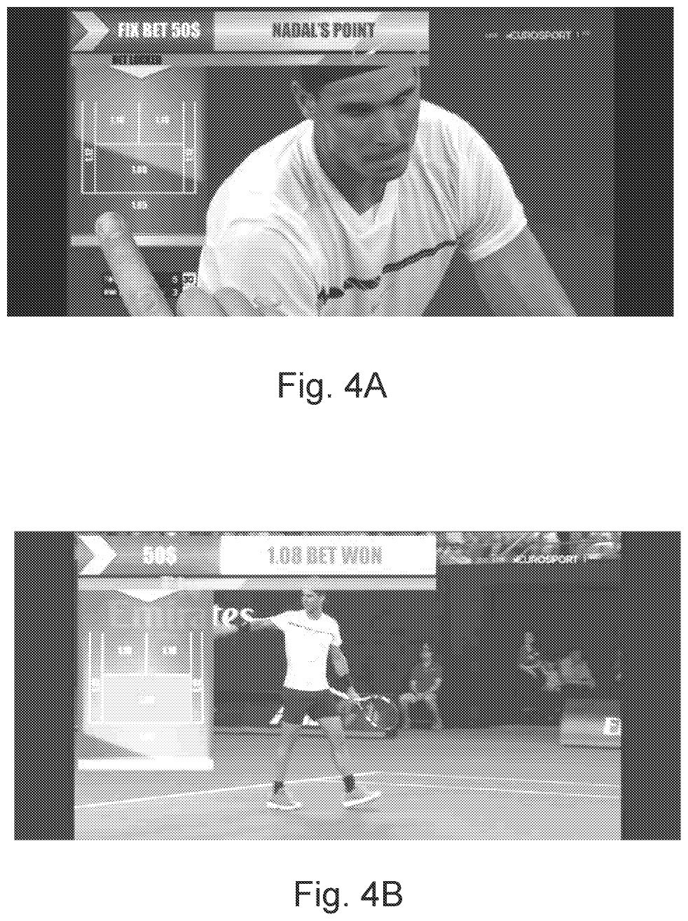

According to an embodiment of the present invention, server 1 associates geographic coordinates for each participating object in the event (e.g., by utilizing GPS tracking sensors worn by soccer players or embedded within the soccer ball). A remotely located user is utilizing a VR device (e.g., VR monocle and headphones connected to a computerized device such as a smartphone running a suitable mobile application of system 10) for experiencing the live event and for choosing proposed betting events by system 10, or for initiating a betting event. For example, the user focus on a player who is about to kick a soccer corner kick (i.e., aims his/her head to the player for a predefined period of time) for receiving open betting events or for initiating a new betting event related to the possible outcomes, such as “Which player will receive the ball?”. As soon as a betting event UI is displayed (shown in FIGS. 4-6) the user can enter a stake to a desirable outcome (e.g., through a smartphone touch screen, a VR glove, etc.) thereby take a bet.

In contradiction to prior-art wagering methods in which the betting events/outcomes are known in advance (e.g., before the live sporting event has begun) and the odds for said known betting events are based on previous statistical information, the betting events/outcomes/odds of the present invention can be generated during the live sporting event and therefore are not known in advance, as well as it can be based not on only on statistical information (i.e., a database of past events, conditions, outcomes with associated odds and actual outcomes, which is stored on server 1), but also on the real-time in-venue data and the current performance of players and teams. In addition, the method of the present invention enables to predefine preliminary betting events (i.e., before the live event has begun), and to fulfill the outcomes of the preliminary betting event during the live sporting event, e.g., the system may predefine a betting event (e.g., “Game Win”) prior to the beginning of the live sporting event, and according to the real-time situation/development of the event (e.g., team A is leading the event for three quarters) the system fulfills possible outcomes (e.g., “Team A will lead by X points or more”, “Team A will lead by less than X points”, “A draw”, “Team B will win the game” etc.), and determines the relevant odds for each possible outcome (i.e., the relevancy of the betting event and outcome/s thereof is not completed until approaching as close as possible to the actual time of the betting event. For example, in case of dividing the entire sporting event into 5 minutes intervals each contains plurality of possible betting events, thus as closer the time gets into each interval the system may determine more accurately the terms of the betting event, possible outcomes and determined odds, due to the actual collected data).

The odds herein represent the ratio between the paid reward and the stake taken (e.g., $3.80 rewarded for each $1 stake means an odd of 3.80), wherein a lower probability for a specific outcome (e.g., scoring a soccer penalty kick) in a given combination of situational parameters (e.g., within the first half of the game, kicked by a specific player who is currently suffers from exaggerated sweating and a current heart bit which is 30% lower than the player's average heart bit in past game's first half), results with higher odd for the specific outcome.

According to another aspect of the invention, while the live sporting event is currently in-progress, system 10 receives real-time data from the one or more sensors 2 and may use the received data in the generation process of one more betting events, referring to actual emerging in-venue conditions (e.g., a breaking offence within a soccer game). The Internet of things (IoT) sensors 2 may include wearable sensors that are configured to provide real-time data relative to physical performance of the wearer (i.e., of an athlete, sportsman or team member) such as miniature magneto-inertial sensors or other types of sensors ideal for obtaining sport performance measures during competition, motion tracking sensors (e.g., GPS) or any other forms of “in-field” sensors (i.e., sensors suitable to provide data relative to activities that occur in real-time during live sporting events and may include data relative to the weather, pitch condition, crowed or other suitable in-venue data), one or more cameras suitable to capture activities that occur during the live sporting event, etc.

According to some embodiments of the invention, system 10 may further receive live digitized information feeds from one or more sources (e.g., external live news, relevant RSS feeds, a game administrator, etc.). Additionally, the generation of betting events may also involve the usage of data representing statistical information and/or other information relative to previous sporting events (e.g., statistical information about players' performance of each sporting team, information derived from previous matches between the same teams, history of outcomes of events occurred in past athletic competitions, and the like). System 10 may store such data in one or more databases associated with system 10 or generally, it may receive such information from third party sources. Optionally, such live-feed and information can be provided to users, e.g., via an interactive media guidance application (in addition to the generated betting event), as analytics for their guidance in predicting the outcomes of specific conditions relating to the activities at the live sporting event.

According to an embodiment of the invention, real-time information (i.e., sensors' data, live-feeds, etc.) and information based on previous events and players' performance (i.e., statistics, previous matches, etc.) are utilized by system 10 to extract analytics in generating betting events and predicting outcomes and/or determining odds of specific outcomes related to activities that may occur at sporting events.

In one exemplary embodiment, pre-defined rules are used in conjunction with the analytics to formulate automated system-generated betting events which are presented to users for a limited period or specific period of time in accordance with a live sporting event. Each betting event has a starting time and ending time in accordance with the progress of the live sporting event (i.e., the duration of each betting event is limited), thus during a single live sporting event a plurality of betting events (that are related to that sporting event) can be provided. For example, system 10 may provide various contemporaneous betting events (i.e., betting events that, at least partially, may have overlapping period), betting events that can be provided one after the other (e.g., when one betting event ends another betting event starts). System 10 may credit a user who is able to predict the outcome of a betting event before the duration of the betting event expires. Consequently, as the sporting event progresses in real-time, more betting events are presented to the users by the system.

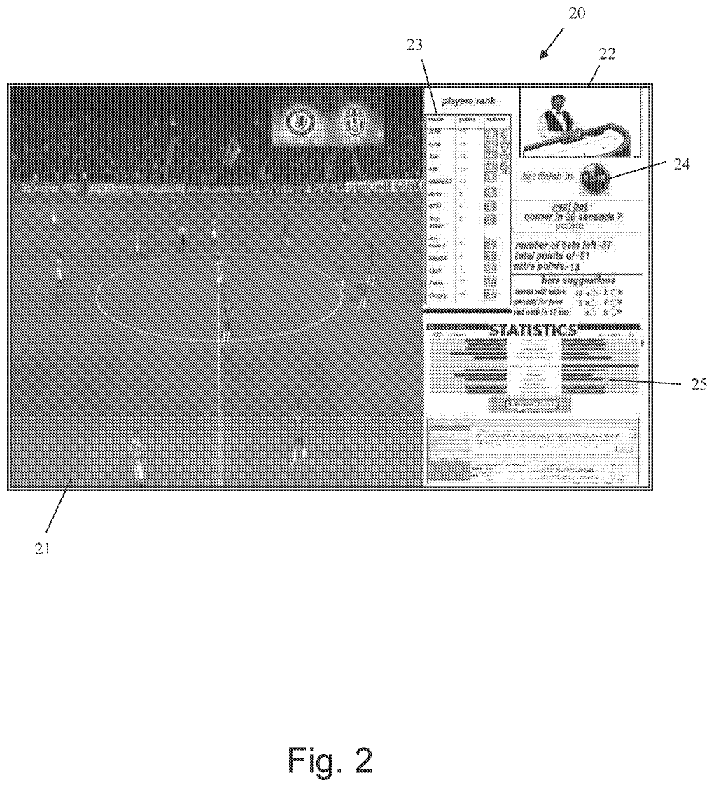

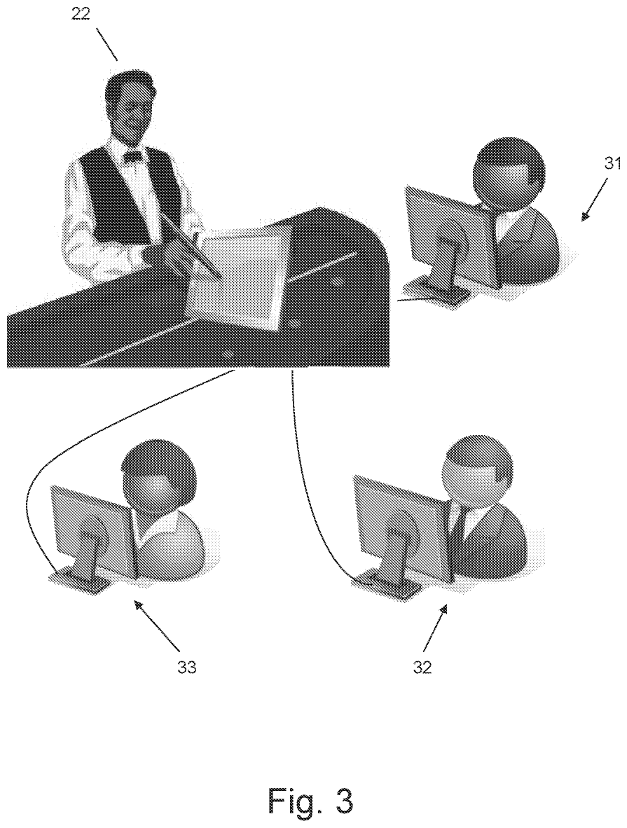

FIG. 1B is a block diagram representing a possible configuration of the computing elements of the proposed wagering system 10, according to an embodiment of the invention, in which system 10 comprises of a statistical module 11, comprising a statistical database (i.e., stored in computer 1) of a plurality of past events 12a, various conditions 12b occurred during past events 12a including the inclusive information associated each condition 12b (e.g, in-venue information received from sensors 2, and when said condition 12b was ongoing), actual past outcomes 12c (i.e., the final actual outcome for each past condition 12b and the calculated statistical odd 12d for each outcome 12c, and a machine learning module 13 comprising machine learning algorithms (also referred to as “adapted to analyze the mass historical statistics” with new received information, and to update the odds 12d of stored outcomes 12c accordingly. System 10 further comprises a dynamic module 14 (i.e., active computing module running on server 1) comprising a dynamic information module 15, dynamic machine learning module 16 and betting event generator 17, wherein betting events generator 17 can either initiate a new betting event and possible outcome/s by receiving a command from a game administrator (shown in FIG. 2), or according to information received from dynamic information module 15. As soon as a betting event was initiated, the betting event generator 17 considers received information from dynamic information module 15 to generate one or more relevant outcomes. Furthermore, betting event generator 17 communicates with statistical module 11 to check if the generated outcomes with the information received from dynamic information module 15 correspond (within a predefined tolerance) with existing outcomes 12c of corresponding conditions 12b and events 12a. Whenever the newly generated outcomes are new, dynamic machine learning module 16 is employed to calculate odds for the new outcomes, based on statistical outcomes 12c with the closest characteristics (i.e., including past dynamic information related to outcomes 12c in view of the new dynamic information received from dynamic information module 15. Finally, betting event generator 17 generates the betting event, outcomes and calculated odds to be presented by system 10 (shown in FIGS. 3-6).

Following the ending of the betting event, betting event generator 17 transfers the actual data of the event, conditions and actual outcomes thereof (i.e., realized outcomes and unrealized outcomes on which were open for wagers) to statistical module 11, in which entirely new outcomes (i.e., not included with the past outcomes 12c are stored as is, and similar outcomes (i.e., similar to outcomes 12c) are analyzed by machine learning module 13 following by updating odds 12d for outcomes 12c.

According to an embodiment of the invention, the self-learning system involves machine learning methods adapted to provide betting events according the user's betting preferences and the user's betting habits. Alternatively, the user may provide the system its preferred type of betting events.

For example, in a soccer match between team “A” and team “B”, a betting event can be automatically generated and presented to the users in a certain point of time during the match. The betting event can refer to one or more outcomes of the live event in form of a questions presented to the user (e.g., “Will team “A” score a goal in the next 3 minutes?”, “Will team “A” score a goal between the 20^{th} minute to the 23^{rd} minute?”, etc.), or refer to one or more outcomes of a specific conditions such as a “corner kick” with the question “Who is the first player to touch the current “corner kick” ?” having multiple possible outcomes, where each outcome is a player's name/shirt number, and wherein each outcome is designated with the relevant odds, the player that will cover the most distance in the next 30 seconds, etc. The generation of this betting event can be influenced by the current physical performance of one or more players of team “A” compared with statistical performance information relative to these players/team, e.g., an increased performance of these team with respect to previous matches can be a trigger (i.e., a rule) for generating this betting event.

As will be appreciated by the skilled person, the arrangement described in the figure results in an online and live gaming platform which is capable of efficiently generating substantially betting events based on actual team or individuals performance, evolving situations and digitized information feeds during the live event.

Users may accesses system 10 over data network 6 via a User Interface (UI) that can be part of a guidance application, by using various types of dedicated electronic devices such as STB (e.g., using a remote control, a wireless keyboard or other suitable input device that can be associated with the STB), mobile devices, desktop computers, etc. Accordingly, it will be understood from the foregoing description that various embodiments of the present invention described herein are generally implemented as a special purpose or general-purpose computer including various computer hardware as described herein.

All the above will be better understood through the following illustrative and non-limitative examples.

FIG. 2 schematically illustrates an exemplary User Interface (UI) 20 that can be implemented in set-top boxes, according to an embodiment of the present invention. UI 20 may include the following elements: a live broadcast of a sporting event 21, a visual representation of a game administrator 22 (e.g., an avatar, a human operator, trading team or a bookie), players ranking table 23, a duration indicator 24 that indicates the remaining time until the current betting event ends (i.e., a user may participate in the betting event related to the possible outcomes in the next predefined period of time such as 1, 5, 10 mins and has to enter a stake before the betting event ends), statistics information 25, betting suggestion provided by different users, live chat, user's betting preferences and so on.

According to one embodiment of the present invention, the game administrator 22 is a human operator that may feed the system with betting events generated either before or during the live sporting event (e.g., the human operator may use a dedicated “dealer” interface to selectively provide one or more system-generated betting events). The human operator can manage the dealer interface from any suitable computer system. According to some embodiments of the invention, the human operator and one or more users may be located in the same room (e.g., playing around the same table like in a casino oriented environment as shown in FIG. 3), where each user 31-33 is provided with its own terminal device (e.g., tablet, PC, or any other equipment provided with the guidance application and is capable of communicating with the other terminal devices and/or the computer system of the game administrator 22 and with server 1 of system 10).

According to another embodiment of the present invention, the game administrator 22 is a virtual operator, this might be depend on the nature of the sporting event, wherein betting events are generated before or during to the live sporting event and can be provided to the users in real-time during the live sporting event. The game administrator 22 can play with a single user and/or with a plurality of users. Optionally, one or more possible outcomes (i.e. betable events) can be generated prior to the beginning of the live sporting event and can be provided to the users during the sporting event. For example, the possible outcome can be generated based on previous performance of individual players or team performance.

The following figures show screenshots examples of interactive media guidance provided with betting events adapted for different live events, according to some embodiments of the invention.

FIG. 4A shows a UI screen shot of the proposed wagering system taken during a live tennis match between two players, according to an embodiment of the present invention, in which a betting event is produced for a “NADAL's POINT” condition in which users may bet (i.e., predict) regarding where the tennis ball will hit the court in the next following serve. In this example, each section of the tennis court is an outcome, assigned with a different odd (as can be seen in the top left corner in the figure). FIG. 4B shows the winning bet after the betting event ended (see the highlighted section of the tennis court in the figure, the one with the 1.08 odds).

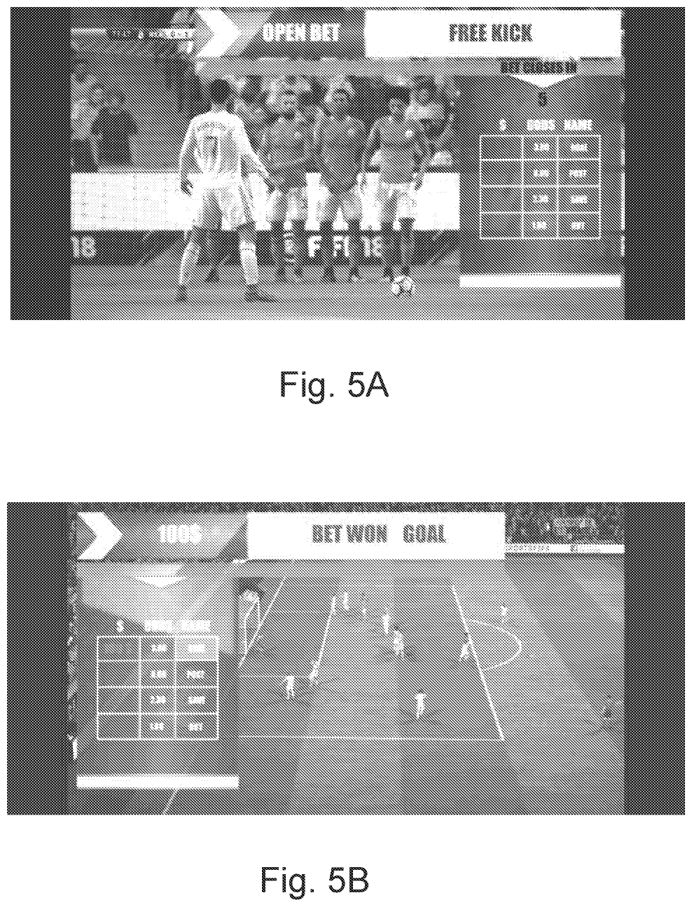

FIG. 5A shows a UI screen shot of the proposed wagering system taken during a live soccer match between two teams, according to an embodiment of the present invention, in which a betting event is produced for a “FREE KICK” condition in which users may bet (i.e., predict) regarding the outcome of an upcoming free kick. In this example, 4 possible outcomes are provided (goal, post, save or out) wherein each possible outcome assigned with a different odd. In this example, an odd of 3.80 is assigned to the outcome of the player that will kick the ball will actually score a goal, odds of 8.00 is assigned to the outcome of the ball will hit the gate's post, an odd of 2.30 is assigned to the outcome of the goalkeeper will save the gate and an odd of 1.80 to the outcome of the ball goes out of the field. FIG. 5B shows the winning bet after the betting event ended (in this example, bet won goal—see the highlighted indication in the figure).

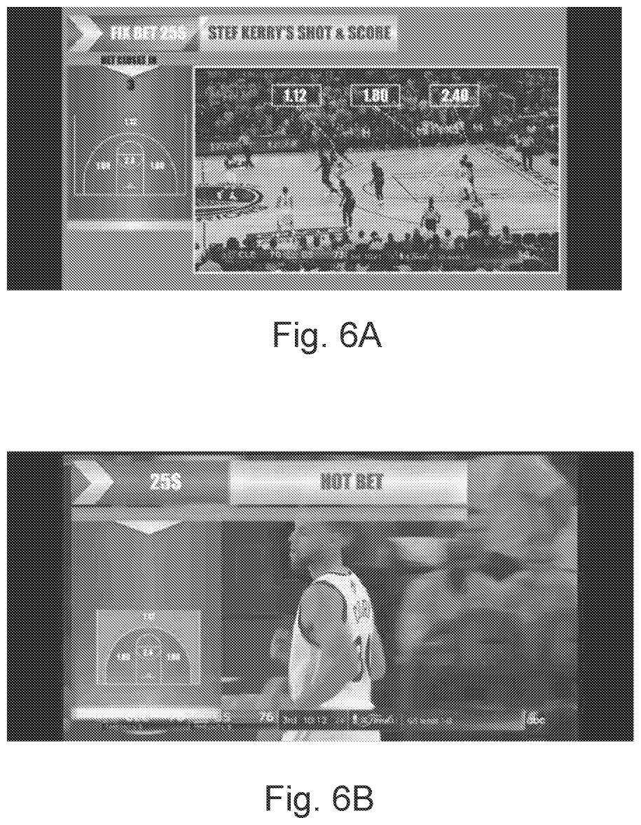

Similarly, FIGS. 6A and 6B show odds of a basketball player to shot and score form different sections of the field.

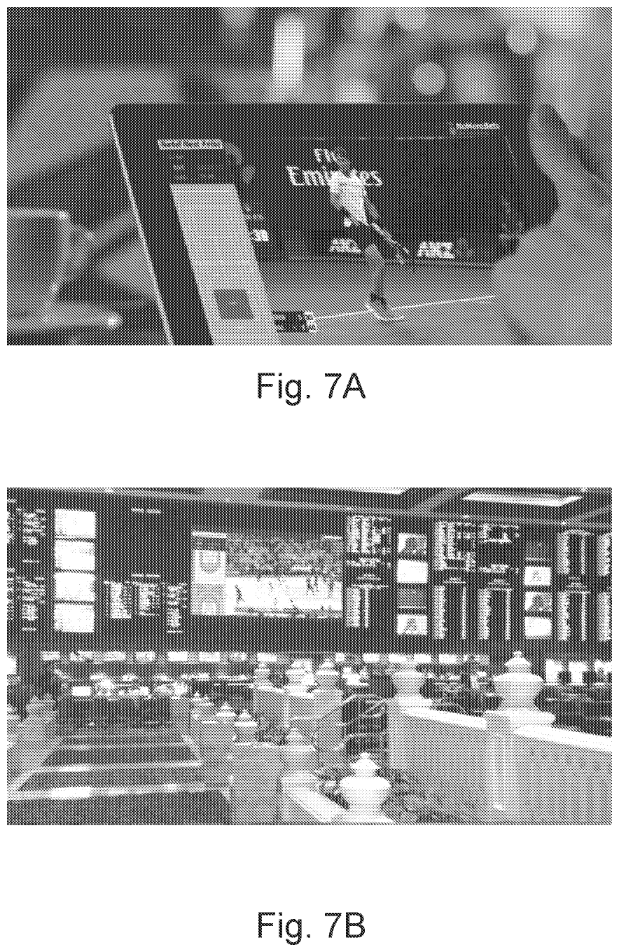

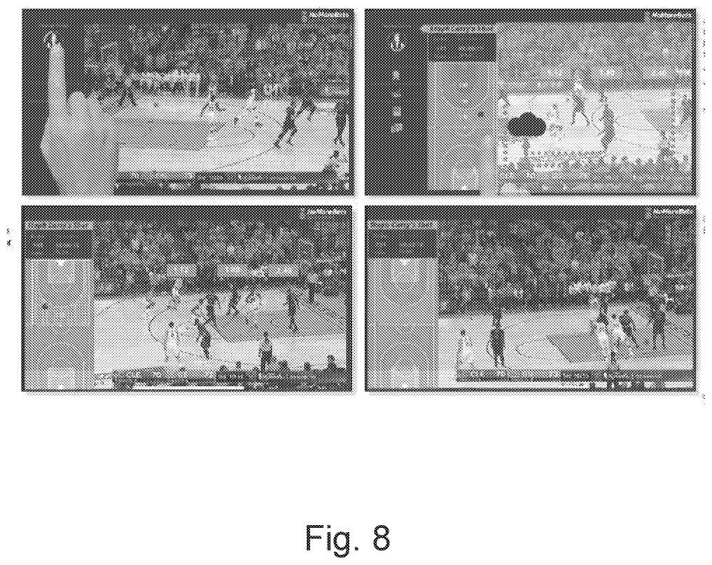

FIGS. 7A and 7B illustrate further possible implementations of the proposed wagering system, according to an embodiment of the present invention, where FIG. 7A illustrates a mobile device UI and FIG. 7B illustrates a public wagering hall. FIG. 8 illustrates examples of possible implementations of the proposed wagering game, according to an embodiment of the invention, which shows in-venue data from plurality of objects such as players, crowd, court, etc.

All the above description and examples have been given for the purpose of illustration and are not intended to limit the invention in any way. Many different mechanisms, methods of analysis, electronic and logical elements can be employed, all without exceeding the scope of the invention.

1. A method for providing a smart-venue based wagering game during a live event, comprising:
a) receiving, in real-time from one or more sensors, in-venue data;
b) receiving data relative to statistical information relative to said live event;
c) utilizing said received data and in-venue data in accordance with the real-time situation/development of the live event for calculating the occurrence probability of one or more outcomes of evolving situations and their corresponding odds in a specific period of time during the progress of said live event; and
d) generating one or more betting events, by a game server, wherein each of said betting event is based on said probability calculation and corresponding odds.

2. A method according to claim 1, wherein the one or more sensors are selected from the group consisting of: wearable sensors that are configured to provide real-time data relative to physical performance of the wearer, motion tracking sensors, “in-field” sensors, cameras or any combination thereof.

3. A method according to claim 2, wherein the wearable sensors are miniature magneto-inertial sensors or other types of sensors suitable to provide data relative to activities that occur in real-time during live sporting events.

4. A method according to claim 2, wherein the “in-field” sensors configured to provide data relative to the weather, pitch condition, crowd or any other form of in-venue data.

5. A method according to claim 1, further comprising allowing one or more users to participant in the wagering game and to selectively bet on possible outcomes of the generated betting event.

6. A method according to claim 5, further comprising closing the betting event after a selected interval such that no further bets can be added to said betting event and terminating said betting event.

7. A method according to claim 6, upon termination of the betting event, crediting winners of each of said betting events.

8. A method according to claim 5, wherein each of the one or more players participates in the wagering game via an interactive media guidance application adapted to run on a terminal device and to further communicate with the game server.

9. A method according to claim 8, wherein the terminal device is selected from the group consisting of: set-top-box, smart TV, personal computer, computer based mobile device, or any other equipment provided with the guidance application and is capable of communicating with the other terminal devices and/or the game server.

10. A method according to claim 1, wherein the wagering game is playable in a casino oriented environment.

11. A method according to claim 1, further comprising a betting widget for interfacing with the wagering game through external computing environments.

12. A method according to claim 8, wherein the interactive media guidance application is provided with a user interface that includes the following elements: a broadcast or other representation of the live event in combination with data relative to betting events.

13. A method according to claim 1, wherein the data relative to betting events comprises one or more of the followings: a visual representation of a game administrator, a ranking table of the participant users, a duration indicator of the current betting event, stopwatch, bets suggestions, live and historical statistics, chat or any combination thereof.

14. A method according to claim 8, wherein the user interface further comprises representation of betting suggestion provided by the participant users.

15. A method according to claim 8, wherein the user interface further comprises live chat for allowing the interaction between the participant players.

16. A method according to claim 1, wherein the in-venue data relative to performance of a team and/or one or more individual players.

17. A non-transitory computer-readable medium comprising instructions which when executed by at least one processor causes the processor to perform the method of claim 1.

18. A system for providing a smart-venue based wagering game during a live event, comprising:
a) one or more sensors for obtaining in-venue data;
b) at least one source for providing statistical information relative to said live event; and
c) a processing unit, configured to receive data from the at least one source and in-venue data from the one or more sensors, to calculate, in accordance with real-time situation/development of the live event, the occurrence probability of one or more outcomes of evolving situations and their corresponding odds in a specific period of time during the progress of said live event, and to generate one or more betting events, wherein each of said betting events is based on said probability calculation and corresponding odds.
